(19) United States
(12) Patent Application Publication
(10) Pub. No.: US 2001/0050676 A1
(43) Pub. Date: Dec. 13, 2001

(54) "Smart Server" electronic servers' pad

(76) Inventor: Jozsef Kocsis, Canton, GA (US)

Correspondence Address: JOZSEF KOCSIS, 200 CANTERBURY RIDGE PKWY #408, CANTON, GA, 30114, US

(21) Appl. No.: 09/873,090

(22) Filed: Jun. 1, 2001

Related U.S. Application Data
(60) Provisional application No. 60/208,621, filed on Jun. 1, 2000.

(51) Int. Cl. G09G 5/00

(52) U.S. Cl. 345/173; 345/179

(57) ABSTRACT

A small hand held touch screen operated computer terminal with rechargeable battery for exclusive use of the restaurant industry. When the software of the operating system of the main computer terminal of the restaurant is programmed in to said device that provides wireless communication between the users and the kitchen of the restaurant while registering the orders with the main terminals.

### BACKGROUND OF THE INVENTION

Restaurants all over the country, especially high volume restaurants and restaurant chains are using computers to process the guests' orders. Several different brands of those computers are available on the market such as Micros, NCR, Panasonic etc. Those computers are operated either by keyboards or by touch screens

The most commonly used computer system used by restaurants is Micros and uses touch screen technology.

Those computers called the terminals are placed at the service stations of the restaurants. Some restaurants have two or more of those terminals depending on the size of the establishment. The servers can log on by entering a numeric code or by swiping a magnetic card assigned to them. After taking the orders at the guests' tables using the regular paper servers' pad they enter the orders in to the computer terminals than the terminals send the orders to the appropriate stations in the kitchen.

The same terminals are used to print the guests' checks, swiping their credit cards to obtain authorization numbers and to print credit card receipts.

Despite the sophistication and reliability of those computer terminals they all have the same disadvantages. The fact that only one person can use them at a time. Not having enough terminals to send in the orders on time is a constant problem especially in high volume restaurants.

Servers serving large parties or separating tickets for large parties often occupy the terminals for a long period of time disabling others to use the terminals. Too many users using the terminals in a short period of time can easily overload the system resulting a system crash. In that case the entire computer system in the restaurant must be turned off and restarted.

Other servers waiting on line to send their orders or waiting for the system to restart can easily be sidetracked, orders can be late or missed. Late or missed orders cost the restaurant industry millions of dollars each year.

Small hand held computers or pocket PCs were introduced to the market a few years ago. Several of them available such as Palm, Casio, Handspring, Hawlett Packard etc. Most of those designed to store data and retrieve the stored data. Some of the newer devices can be used for wireless communication and can be connected to any computer systems. Those devices are extremely sophisticated and very reliable.

### BRIEF SUMMARY OF THE INVENTION

This invention the “Smart Server” electronic servers' pad or hand held servers' terminal combines the technologies of the wireless pocket PCs and the computer terminals used by restaurants.

The “Smart Server” electronic servers' pad provides the restaurant industry a much needed device that can be used by all the servers at the same time using wireless communication between the servers and the kitchen and between the servers and the restaurants' computer terminals.

### BRIEF DESCRIPTION OF THE SEVERAL VIEWS OF THE DRAWING

FIG. 1 shows the device with the protective cover closed showing the “Smart Server” logo on it.

FIG. 2 shows the pen or pointing device to be used on the touch screen with the “Smart Server” logo on it.

FIG. 3 shows the right side of the device with the on/off button and the contrast adjusting button.

FIG. 4 shows the device with the protective cover open. It shows the pen holder inside the protective cover, the touch screen of the device and the “+” shaped scroll button located under the touch screen.

FIG. 5 shows the bottom side of the device with the recharging connections and a curve on the bottom side of the protective cover for easy opening.

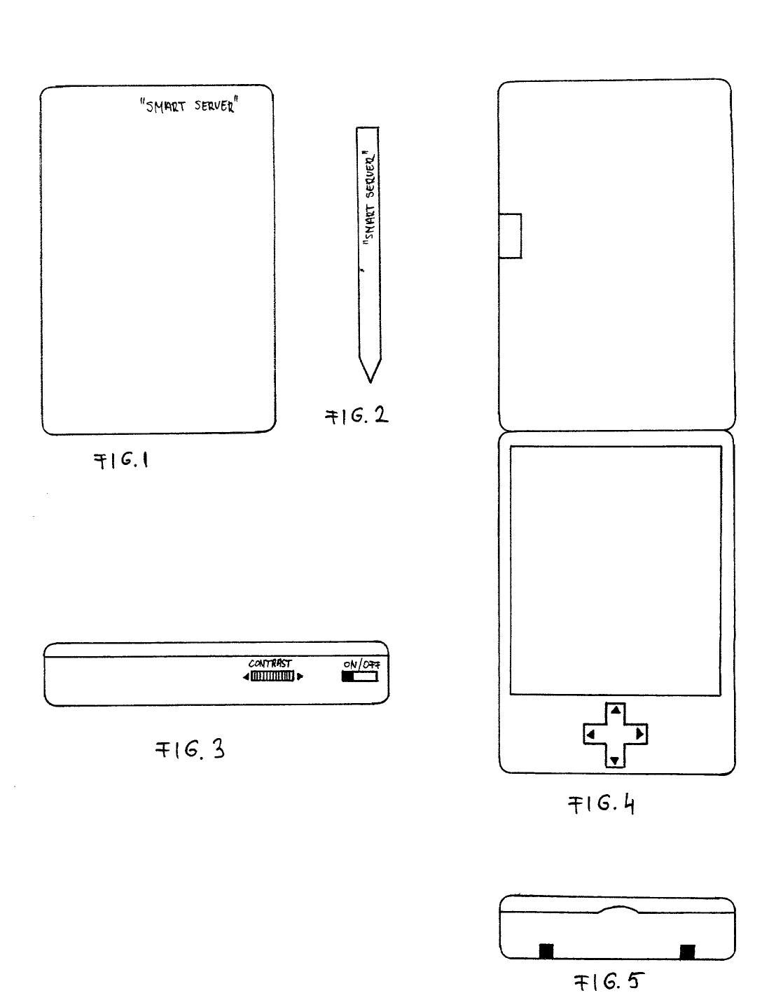

### DETAILED DESCRIPTION OF THE INVENTION

The device itself is a small rectangular shaped hand held computer with curved edges made from durable plastic or from light weight metal and operated by a rechargeable battery. It has a large touch screen that is operated by using a pen or pointing device already used with pocket PCs. A durable plastic cover protects the touch screen and has a small holder for the pointing device inside the cover. The protective cover opens upward that way the device can be easily operated by both right handed and left handed users. The on/off button is located on the side of the device next to it the contrast button to adjust the contrast of the touch screen to a comfortable level for each individual users. The only other manual button is a “+” shape button located under the touch screen to scroll the pages on the screen vertically and or horizontally. The use of this button enables the users of the device to program large pages on the touch screen not limited to the actual size of the screen. All the other functions are operated by the touch screen. This invention has all the options of the existing computer systems used by restaurants. All items of the menu and the bar are programmed in to it according to the specifications of each restaurants divided by menu categories as appetizers, salads, entrees, side dishes, specials, desserts. The bar items are categorized as wines, beers. Liquors and cocktails are listed in alphabetical orders. A “Retail Merchandise” button is optional for establishments selling cigars, caps, shirts etc.

Operating this device is very simple. After turning it on a numeric keypad will appear on the screen. The servers can log in by entering a numeric code assigned to them. A plastic pointing device is used to press the keys on the touch screen those will be provided with every unit. After entering the personal code the server will assign the table by number and enter the number of guests. As an option the floor plan of the restaurant can be programmed on the screen with the table numbers.

Once the table is assigned and the number of the guests entered the menu categories will appear on the screen. The screen can be scrolled up and down, to the left and to the right by pressing the scroll button located right below the touch screen. After entering the order the order can be sent directly to the kitchen or can be stored in the device and sent later. Storing orders without sending them is an important feature when special items have limited availability. Using this feature the servers can reserve certain items of the menu and order them later even if the item is already sold out by the time of the ordering. To store the orders without sending it to the kitchen is also a tremendous help for servers working on large parties. This feature is not available on any existing computer systems used by restaurants.

By pressing the “save order” key the order is stored in the device and the background of the table number will change color indicating that the order is stored but not yet sent. By pressing the “send order” key the order is sent to the printers of the appropriate stations of the kitchen and or to the bar. The background of the table number will change color again so the servers looking at the screen will be able to see the status of all their tables. This helps prevent servers' confusion often resulting late or missed orders. At the same time the order also registered at the main server terminals located in the restaurant where the guest receipts can be printed later.

By pressing the “modifier” key in each menu category a second screen will appear with possible special instruction most often requested by the guests.

A “special instruction” key is located in every menu categories. Pressing that key an alphabetical keypad will appear so the servers can type in any special requests of the guests.

A “see server” button is located in every menu categories when the special instructions of the guests are too complicated to type in or verbal communication with the kitchen is preferred.

When the price of a menu item includes salad or side dish by pressing the item on the menu screen will prompt the servers to another screen to order those side items without charging for them.

Pressing the “transfer” key orders can be transferred from one table to another.

Pressing the “split ticket” key tickets can be separated, up to five tickets per screen.

Pressing the “begin by name” key tickets can be opened by entering the names of the guests. This is a very important feature especially for large cocktail parties when the guests are responsible paying for their own drinks.

A “don't make” button is also located in every menu categories.

Folding back the protective cover over the touch screen temporarily turn off the device and it can be easily stored in a pocket of any servers' uniforms. At the end of the shift they can be stored on their rechargeable bases and charged overnight.

This device is for the exclusive use of the restaurant industry. Using this invention the servers can take the orders, store the orders in the device or send the orders directly to the printers in the different stations of the kitchen right from the guests' tables without using a regular paper pad than going to the terminals, enter the orders in to the terminals and send them to the kitchen.

Using the wireless technology this device can send the orders to the printers in the kitchen bypassing the use of the terminals to send the orders meantime registering the orders in the terminals.

These devices can be used by all the servers at the same time without waiting on line at the terminals to turn their orders in especially in case of large parties. The terminals would have to be used only for printing guests' receipts, swiping credit cards to obtain authorization and for printing credit card receipts. That saves tremendous amount of time making the operation of high volume restaurants much more smoother and much more efficient, also reducing the risk of system overload that often causes system crash in restaurant computer systems.

Reducing the risk of missed or late orders this device could potentially save millions of dollars for the restaurant industry each year.

Despite that most paper pads used in the restaurant industry are made from recycled paper, eliminating the use of paper pads this invention would also have a great environmental impact by saving hundreds of thousands of tons of paper each year.

The wireless technology enables this device to work with all existing computer systems used by the restaurant industry. The specific programs of the different systems can be programmed in to the device eliminating the need of a costly system change or the time consuming process of training employees how to use new systems as they are using their old system in a new faster and more efficient way.

This invention can be made from different lightweight materials can be different in colors. It's size and shape can be slightly different and as technology progresses more new features can be added on this device meeting the ever growing demands of the restaurant industry of the new millenium.

It is to be understood that the drawings are designed for purposes of illustration only, and are not intended as a definition of the limits and scope of the invention disclosed.

I claim:

1. My invention the “Smart Server” electronic servers' pad comprising a flat body made from lightweight material. Said body has a large touch screen and a “+” shaped scroll button under the touch screen. The front of said body has a protective cover that opens upward and has a small holder for the pointing device used to operate the touch screen of the device. The on/off button and contrast button are located on the side of said body. Said device is operated by a rechargeable battery the recharging connections are located on the bottom of said body. Said device is designed for the exclusive use of the restaurant industry.

2. When programming the different software of the different operating systems of the main computer terminals of the restaurants according to their different specifications, said device provides a wireless communication between the users and the kitchen while registering the orders with the main computer terminals.

3. The “save order” feature of said device enables the users to store the orders in said device for later processing. The use of said device can eliminate the use of conventional paper pads used to take the guests' orders.
